(19) United States
(12) Patent Application Publication
(10) Pub. No.: US 2026/0180952 A1
(43) Pub. Date: Jun. 25, 2026

(54) TRAFFIC ISOLATION, SECURITY, AND NETWORK RESILIENCE IN ANALOG ELECTRICAL CIRCUIT SWITCH (AECS) SYSTEMS

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/428,050

(22) Filed: Dec. 19, 2025

Related U.S. Application Data
(60) Provisional application No. 63/737,540, filed on Dec. 20, 2024.

(51) Int. Cl. H04L 9/40

(52) U.S. Cl. CPC H04L 63/0227; H04L 63/1416; H04L 63/1425

(57) ABSTRACT

A device may include a plurality of digital signal processors (DSPs) and a plurality of analog crossbars connected to the DSPs. A microcontroller unit may be operable to facilitate network isolation.

### RELATED APPLICATION

This application claims the benefit of U.S. Provisional Application No. 63/737,540, filed Dec. 20, 2024, the disclosure of which is incorporated herein by reference in its entirety.

The examples discussed in the present disclosure are related to traffic isolation, security, and network resilience in analog electrical circuit switch (AECS) systems.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A device includes a plurality of digital signal processors (DSPs) and a plurality of analog crossbars connected to the DSPs. The DSPs are configured to facilitate network isolation through traffic segmentation. The system supports dynamic security zones, real-time policy enforcement, and adaptive access control. Crossbars enable redundant pathways and failover mechanisms to ensure uninterrupted operation. Asynchronous operation and localized synchronization provide rapid reconfiguration and scalability. The system implements hierarchical policies, monitors crossbar connections for violations, and uses tamper-evident logs for auditing. Advanced features include machine learning for predictive traffic management and time-division multiplexing for efficient resource allocation. The device integrates seamlessly with legacy systems while maintaining robust traffic isolation and security. A method may include connecting a plurality of digital signal processors to a plurality of analog crossbars, and facilitating network isolation at the plurality of DSPs.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including digital signal processors and analog crossbars.

FIG. 2 illustrates an example process flow of a device for traffic isolation.

FIG. 3 illustrates an example communication system operable for traffic isolation.

FIG. 4 illustrates a diagrammatic representation of a machine in the example form of a computing device within which a set of instructions, for causing the machine to perform any one or more of the methods discussed herein, may be executed.

FIG. 5A illustrates an example block diagram of a data center.

FIG. 5B illustrates an example switch device.

FIG. 5C illustrates an example switch device.

FIG. 5D illustrates an example switch device.

### DESCRIPTION OF EMBODIMENTS

The systems and methods of the examples described below pertains to the field of high-speed network switches and physical media dependent (PMD) devices with crossbar-based architectures. Modern networks often experience fluctuating traffic patterns and congestion, using dynamic and efficient allocation of crossbar resources. Traditional static or fixed-path routing techniques lack the flexibility to respond to real-time network demands, often leading to inefficient bandwidth utilization and increased latency.

Security and traffic isolation may allow the analog electrical circuit switch (AECS) to be used in sensitive environments. The AECS may facilitate provable traffic isolation and resilience. In addition, security and resilience may be provided within the AECS which may protect against unauthorized access and maintain operation during failures or attacks.

Examples of the described herein will be explained with reference to the accompanying drawings.

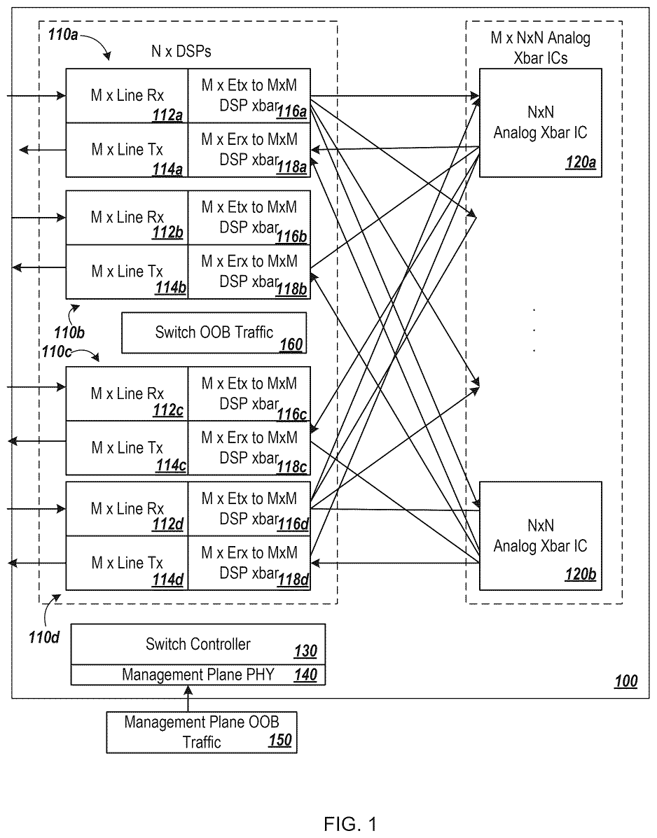

As illustrated in FIG. 1, an AECS 100 may include one or more digital signal processors (DSPs) 110a, 110b, 110c, 110d. The AECS may include a switch controller 130. The AECS may include one or more analog crossbars (“xbar”) integrated circuits (IC) (e.g., analog crossbars 120a, 120b).

The DSPs 110a, 110b, 110c, 110d may be devices integrating layer 1 (L1) for line and switch side inputs and outputs. A DSP 110a may include an M x Line Rx 112a, an M x Line Tx 114a, an M x ETx to MxM DSP xbar 116a, and an M x ERx to MxM DSP xbar 118a. A DSP 110b may include an M x Line Rx 112b, an M x Line Tx 114b, an M x ETx to MxM DSP xbar 116b, and an M x ERx to MxM DSP xbar 118b. A DSP 110c may include an M x Line Rx 112c, an M x Line Tx 114c, an M x ETx to MxM DSP xbar 116c, and an M x ERx to MxM DSP xbar 118c. A DSP 110d may include an M x Line Rx 112d, an M x Line Tx 114d, an M x ETx to MxM DSP xbar 116d, and an M x ERx to MxM DSP xbar 118d. A DSP xbar may be a digital crossbar integrated in the DSP.

A physical media-dependent (PMD) device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In one example, the switch controller 130 may be a microcontroller unit (MCU). Alternatively or in addition, the switch controller 130 may be a DSP.

Switch out-of-band (OOB) traffic may be traffic among the SC 130, DSP 110a, 110b, 110c, 110d, analog crossbars 120a, 120b carried on a different network and physical layer than IB; may be carried on analog crossbars 120a, 120b with redundancy.

An “Xbar IC” may be an analog Xbar IC which may be a chip implementing an analog crossbar with input and output lanes.

Management plane OOB traffic may be traffic from outside the AECS via management plane physical layer (PHY) to configure and manage the AECS.

A device may include DSPs 110a, 110b, 110c, 110d and analog crossbars 120a, 120b that may be connected to the DSPs 110a, 110b, 110c, 110d. A switch controller 130 may facilitate network isolation. For example, different data streams may be isolated to facilitate physical and logical separation of network segments within the crossbar system. Unauthorized data access and provable isolation may be facilitated between different network segments.

Different policies may be applied in which crossbar connections may be permitted or banned. A switch controller 130 may apply a policy for permitting a crossbar connection between DSPs 110a, 110b, 110c, 110d and analog crossbars 120a, 120b. A switch controller 130 may apply a policy for banning a crossbar connection between DSPs 110a, 110b, 110c, 110d and analog crossbars 120a, 120b.

The crossbar connections may be monitored and policy violations may be flagged. A switch controller 130 may monitor the crossbar connection between DSPs 110a, 110b, 110c, 110d and analog crossbars 120a, 120b. When a policy violation is detected, a switch controller 130 may log the policy violation and flag the policy violation.

For example, in some embodiments, AECS 100 employs granular traffic isolation techniques, robust policy enforcement mechanisms, and provable isolation methods to secure network operations. These capabilities enable the AECS to adapt to complex and dynamic network environments, ensuring efficient and secure traffic management.

The AECS 100 may facilitate granular traffic isolation to enhance network security and efficiency. Granularity of traffic isolation may include isolation at various levels, such as a frame level, enabling the AECS to adapt to diverse operations. Frame-level isolation allows grouping of multiple packets into logical units for higher-level management. These isolation techniques may be dynamically applied by a switch controller 130 and monitored by the switch controller 130 to ensure compliance with policy-defined boundaries. In some examples, a security monitoring function may be separated from a security controlling function.

AECS 100 may also manage overlapping policies for shared resources to prevent contention and ensure fair resource utilization. For example, DSPs 110a, 110b, 110c, 110d may implement time-division multiplexing (TDM) to allocate crossbar resources between overlapping traffic zones. Policies for shared resource access may be prioritized based on network conditions, such as traffic type, latency, or bandwidth availability. The switch controller 130 may arbitrate between conflicting policy demands using rule-based or probabilistic decision algorithms to maintain traffic isolation while optimizing resource allocation.

Policy enforcement mechanisms in the AECS 100 may allow for precise control over crossbar connections. Examples of permissible crossbar connections may include point-to-point connections between specific DSPs or crossbars, or broadcast connections limited to designated security zones. Banned crossbar connections may include those that would violate isolation policies by linking traffic from mutually exclusive security zones. A switch controller 130 may dynamically update these policies in response to network conditions, such as changing traffic patterns or detected security breaches.

For example, dynamic policy updates may be facilitated by real-time traffic analysis performed by a switch controller 130. For example, if a security breach is detected in one zone, the affected crossbar connections may be immediately disabled, and new policies may be deployed to reroute traffic through secure paths. The switch controller 130 may act as the central authority to distribute updated policies to all DSPs and crossbars, ensuring synchronized enforcement across the AECS 100.

AECS 100 may provide provable traffic isolation to ensure adherence to policies and prevent unauthorized data access. Logging and auditing capabilities integrated into DSPs 110a, 110b, 110c, 110d and the switch controller 130 may maintain detailed records of crossbar configurations, connection states, and policy enforcement actions. These records may be used to verify compliance with isolation policies and to generate reports for network administrators or auditors.

To further enhance provable isolation, the AECS 100 may incorporate cryptographic verification mechanisms. DSPs 110a, 110b, 110c, 110d and the switch controller 130 may employ cryptographic signatures to authenticate and verify crossbar configurations before they are applied. For example, a digital signature may be generated for each crossbar configuration based on the applied policy, and any attempt to modify the configuration without proper authorization would be flagged and rejected. This ensures that crossbar configurations conform to predefined isolation policies and provide tamper-proof validation of the system's integrity.

The prevention of unintended crossbar configurations may be achieved through fail-safe design and secure logic within the AECS 100. A switch controller 130 may implement safeguards, such as mutual exclusion locks, to prevent conflicting commands from altering crossbar states. Additionally, the switch controller 130 may continuously monitor crossbar configurations and enforce rollback mechanisms to restore the last known good configuration in case of anomalies or unauthorized changes.

In some embodiments, granular traffic isolation within AECS 100 may enable precise control of data flows across multiple security zones, ensuring that traffic is managed at varying levels of granularity, such as packet, frame, or flow level. At the packet level, each individual packet may be classified and routed based on its header attributes, allowing highly specific isolation and traffic handling. Frame-level isolation aggregates packets into logical frames for steady routing across shared resources while preserving isolation. At the flow level, traffic may be isolated based on source-destination pairs, application types, or quality-of-service (QOS), facilitating efficient segregation of data streams in diverse networking environments. A switch controller 130 may dynamically manage these isolation levels in real-time, optimizing traffic flow based on predefined policies and real-time network conditions.

Dynamic reconfiguration of traffic zones within AECS 100 may be achieved through continuous monitoring and adaptive resource allocation. For example, the switch controller 130 may dynamically create, modify, or dissolve security zones based on network activity or emerging threats. Temporary security zones may be automatically generated during periods of high-priority traffic to dedicate crossbar resources for critical operations. As traffic patterns normalize, these zones may merge back into shared resources or dissolve entirely, ensuring efficient utilization of crossbar bandwidth. Such dynamic reconfiguration may minimize latency and ensure uninterrupted traffic flow, even in highly congested or unpredictable network environments.

To manage overlapping policies for shared resources, AECS 100 may employ time-division multiplexing (TDM) to allocate crossbar access across multiple zones. DSPs 110a, 110b, 110c, 110d implement arbitration algorithms to resolve conflicts between zones, prioritizing traffic based on QoS parameters or administrative directives. The switch controller 130 ensures coherence across zones by maintaining a global view of active connections and dynamically reallocating resources as needed. This granular and dynamic traffic isolation enables AECS 100 to adapt to diverse operational demands while maintaining security and efficiency.

Policy management in AECS 100 ensures that crossbar connections adhere to predefined rules governing permissible and banned interactions between DSPs 110a, 110b, 110c, 110d and analog crossbars 120a, 120b. Policies may be categorized into global policies that apply system-wide and zone-specific policies tailored to individual security zones. For instance, a global policy may prohibit connections between high-security and untrusted zones, while a zone-specific policy may restrict bandwidth for non-critical traffic during peak usage. These policies may be enforced dynamically by the switch controller 130, which evaluates connection requests and applies the appropriate rules.

AECS 100 may implement a hierarchical policy management system, allowing for global policies and zone-specific rules to coexist and operate seamlessly. Global policies, established by the switch controller 130, may provide a universal framework for crossbar connections, defining baseline permissions and restrictions that apply across security zones. For example, a global policy may prohibit connections between high-security zones and untrusted nodes, ensuring a steady level of protection throughout the network. Zone-specific policies may inherit these global rules while introducing additional restrictions tailored to each zone. For instance, a critical infrastructure zone may inherit global access restrictions and further limit crossbar connections to authorized nodes with specific credentials, ensuring stricter isolation for sensitive operations.

To maintain system stability and avoid conflicts, AECS 100 may employ real-time policy validation mechanisms before enforcing any updates to crossbar configurations. The switch controller 130 may simulate the impact of proposed policy changes, evaluating their effects on existing crossbar connections, bandwidth allocation, and traffic flows. During this pre-validation phase, the system may identify potential conflicts, such as overlapping resource requests or contradictory rules across zones, and flag them for administrative review. This simulation-based approach ensures that new policies can be safely applied without introducing disruptions or unintended consequences.

Real-time validation may also incorporate predictive modeling techniques to assess the long-term effects of policy updates. For example, the switch controller 130 may analyze historical traffic patterns and anticipate how a new policy might impact resource utilization or latency under peak loads. If the validation identifies potential bottlenecks or vulnerabilities, the system may recommend alternative configurations or suggest additional safeguards. By proactively addressing these issues, AECS 100 ensures that its hierarchical policy framework operates efficiently and reliably, even in dynamic and high-demand environments.

Additionally, AECS 100 supports adaptive policy management, enabling real-time updates to global and zone-specific rules based on evolving network conditions. For example, in response to a detected security threat, the switch controller 130 may temporarily elevate the priority of zone-specific policies, tightening access controls and rerouting traffic to isolate the affected area. Once the threat subsides, the system may automatically revert to the original policy hierarchy, restoring normal operations without using manual intervention. This adaptive capability enhances the flexibility and resilience of the AECS 100, ensuring uninterrupted performance and robust security across zones.

Dynamic policy updates within AECS 100 enable real-time responsiveness to evolving network conditions. For example, in the event of a security breach, the switch controller 130 may revoke existing crossbar connections, reroute traffic through secure paths, and deploy new policies to contain the threat. DSPs 110a, 110b, 110c, 110d work in tandem with the switch controller 130 to monitor network activity and preemptively adjust policies based on traffic patterns, bandwidth usage, or detected anomalies. Such adaptability ensures that AECS 100 maintains optimal performance and robust security under dynamic conditions.

Provable isolation may be advantageous for providing verifiable assurance that network traffic is segmented according to policy. Logs maintained by DSPs 110a, 110b, 110c, 110d and the switch controller 130 may capture crossbar configurations, policy enforcement actions, and traffic routing decisions. Such logs may be stored in tamper-evident formats, such as cryptographically hashed records, ensuring their integrity and utility for audits or compliance purposes. Network administrators may generate detailed reports from these logs to verify that traffic isolation policies have been enforced.

Cryptographic verification of crossbar configurations adds an additional layer of security to AECS 100. Configurations applied to analog crossbars 120a, 120b may be digitally signed by the switch controller 130, using cryptographic techniques to authenticate and verify policy adherence. Unauthorized attempts to modify crossbar configurations may be flagged and rejected, ensuring that the system operates within its intended security parameters. This tamper-proof validation mechanism may provide network administrators with confidence that isolation policies are both enforceable and enforced.

To prevent unintended crossbar configurations, AECS 100 may incorporate fail-safe mechanisms within DSPs 110a, 110b, 110c, 110d. For example, mutual exclusion locks may ensure that conflicting commands cannot alter crossbar states simultaneously. The switch controller 130 may also enforce rollback protocols, restoring the last known good configuration in response to anomalies or policy violations. These safeguards, combined with logging and cryptographic verification, establish AECS 100 as a robust platform for provable traffic isolation and secure policy management.

AECS 100 may also support hierarchical policy enforcement, where traffic isolation policies may be structured based on organizational or operational priorities. For example, a high-priority zone handling sensitive data may have stricter isolation rules and dedicated resources, while lower-priority zones may share resources with other traffic under relaxed policies. The switch controller 130 may dynamically adjust these policies based on real-time traffic demand and administrative directives, ensuring optimal isolation without compromising performance. Accordingly, DSPs 110a, 110b, 110c, 110d may form multiple security zones. Multiple security zones may be implemented and enforced using a secure controller and/or secure logic.

DSPs 110a, 110b, 110c, 110d and/or analog crossbars 120a, 120b may include one or more of a redundant crossbar and/or a failover path to facilitate operation during failover. Failover systems may allow for operation during network disruptions (e.g., using redundant crossbars and multiple failover paths).

DSPs 110a, 110b, 110c, 110d may include redundant input and output lanes, allowing failover and continued operation during system faults. For example, R redundant output lanes may be coupled to the R redundant input lanes via 2×Rx N×N redundant crossbars, where N is the number of DSPs 110a, 110b, 110c, 110d. Alternatively, 1×Rx N×N crossbars may be used when protection against input or output buffer failures is not used in the center crossbars.

Redundancy may also be used for connecting in-band (IB) or out-of-band (OOB) communication. Redundant inputs and outputs may be used for connected IB or OOB communication e.g., for control, synchronization, or other forms of communication. An OOB mode may be used (e.g., 10 GHz) which may be substantially lower power and/or lower data rate than the IB communication rate.

Redundancy may be used in broadcasting. The DSPs 110a, 110b, 110c, 110d and/or switch controller 130 may broadcast to some or all devices (e.g., DSPs 110a, 110b, 110c, 110d) connected to the redundant crossbars. OOB transceivers may be integrated on the crossbar devices, which may communicate via at least one of the R redundant inputs and outputs.

A switch controller 130 may facilitate access control for one or more of authorized traffic or control signals. Alternatively or in addition, secure access controls may be implemented using a switch controller to limit traffic to authorized traffic or to limit control commands so that authorized control commands may configure crossbars or network resources. Security may be enforced by restricting access to AECS 100 configuration.

A device may include DSPs 110a, 110b, 110c, 110d, analog crossbars 120a, 120b, and a switch controller 130. The switch controller 130 may facilitate network isolation. The switch controller 130 may have the functionality discussed with reference to DSPs 110a, 110b, 110c, 110d for facilitating network isolation. The switch controller 130 may apply a policy to physically isolate one or more nodes by physically isolating selected nodes from other nodes. The switch controller 130 may designate one or more DSPs 110a, 110b, 110c, 110d as controllers for other security zones. Separate network controllers may be used for systems where in-band DSP communication is used. Primary network controllers may designate other DSPs 110a, 110b, 110c, 110d as controllers for other security zones as set up occurs.

AECS 100 may leverage asynchronous operation to enhance its flexibility and efficiency, enabling faster reconfiguration and reduced dependence on global timing mechanisms. Unlike traditional synchronous systems that rely on a centralized timing source to coordinate activities across all components, asynchronous configurations may allow DSP 110a, 110b, 110c, 110d and analog crossbar 120a, 120b to operate independently, responding to local conditions in real-time. This decentralized approach minimizes the latency associated with synchronization processes, ensuring that crossbar configurations can be updated rapidly to accommodate dynamic traffic patterns and shifting network demands. For example, DSPs 110a, 110b, 110c, 110d and/or analog crossbars 120a, 120b may operate asynchronously, without relying on centralized management cycles, for faster and more flexible reconfiguration. The AECS 100 may be configured asynchronously (e.g., no MAP cycle, crossbars configured asynchronously).

Asynchronous operation may support faster reconfiguration compared to synchronous systems. In a synchronous system, reconfiguration may use global coordination to ensure components transition seamlessly to a new state, introducing delays as timing signals propagate throughout the network. In contrast, asynchronous configurations may enable localized reconfiguration, where individual DSPs 110a, 110b, 110c, 110d and crossbars 120a, 120b independently adjust their states based on real-time instructions from the switch controller 130. This localized approach may reduce the overhead associated with system-wide synchronization, allowing for near-instantaneous adjustments to crossbar connections and resource allocations.

Asynchronous operation may also reduce reliance on global timing mechanisms, such as IEEE 1588-based synchronization protocols, which can introduce complexity and additional latency in large-scale systems. By allowing DSPs 110a, 110b, 110c, 110d and crossbars 120a, 120b to operate autonomously, AECS 100 eliminates precise global timing alignment, simplifying system design and improving overall scalability. This independence may be particularly beneficial in distributed environments where components may be geographically dispersed or subject to varying network conditions, ensuring performance regardless of external timing variations.

To maintain coordination in the absence of a global timing mechanism, AECS 100 may incorporate localized synchronization techniques between subsets of DSPs and crossbars. For example, DSPs 110a, 110b, 110c, 110d within a single security zone may share a common local timing signal to ensure coherent operation, while crossbars 120a, 120b may dynamically adjust their configurations based on signals from nearby DSPs. This localized synchronization minimizes the risk of timing conflicts while preserving the advantages of asynchronous operation, enabling the system to balance autonomy and coordination effectively.

Localized synchronization may be further enhanced by implementing adaptive timing algorithms that dynamically adjust synchronization intervals based on network conditions. For instance, in zones with high traffic volatility, synchronization intervals may be shortened to enable more frequent adjustments, while stable zones may operate with longer intervals to reduce computational overhead. These adaptive mechanisms may allow AECS 100 to optimize synchronization for each zone, ensuring performance across diverse network scenarios.

Moreover, asynchronous operation may also improve the resilience of AECS 100 by allowing components to continue functioning independently in the event of a localized failure. For example, if a subset of DSPs 110a, 110b, 110c, 110d experiences a timing disruption, other components can continue operating unaffected, maintaining network stability and minimizing service interruptions. The switch controller 130 can dynamically reconfigure the affected zone to restore normal operation without impacting the rest of the system. Additionally, asynchronous operation facilitates compatibility with legacy systems and multi-vendor environments, where timing protocols and synchronization standards may vary. By decoupling its operation from global timing dependencies, AECS 100 can seamlessly integrate with diverse infrastructure, supporting hybrid deployments that include both legacy and modern components. This interoperability enhances the system's utility in complex networking environments, enabling gradual upgrades and minimizing disruption during transitions.

Crossbars may be configured by a management plane which runs inside or outside the AECS 100 (e.g. via a switch controller 130). This allows the DSPs and switches to settle and/or reacquire either with a fixed time, by polling the DSPs and/or analog crossbars, or by interrupts/communications from the DSPs and/or analog crossbars. In addition or alternatively, the AECS may be an optical circuit switch (OCS). Thus, any technique suitable for an AECS may be applied to an OCS.

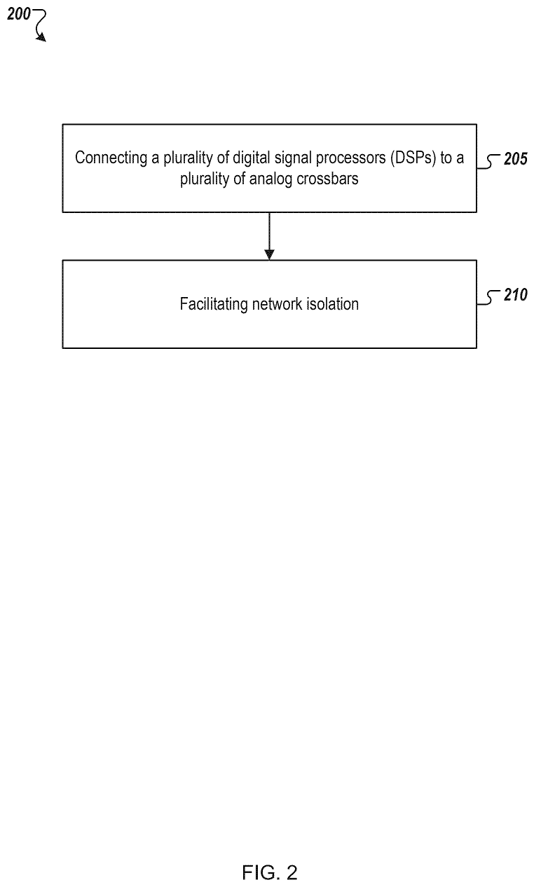

FIG. 2 illustrates a process flow of an example method 200 of traffic isolation, in accordance with at least one example described in the present disclosure. The method 200 may be arranged in accordance with at least one example described in the present disclosure.

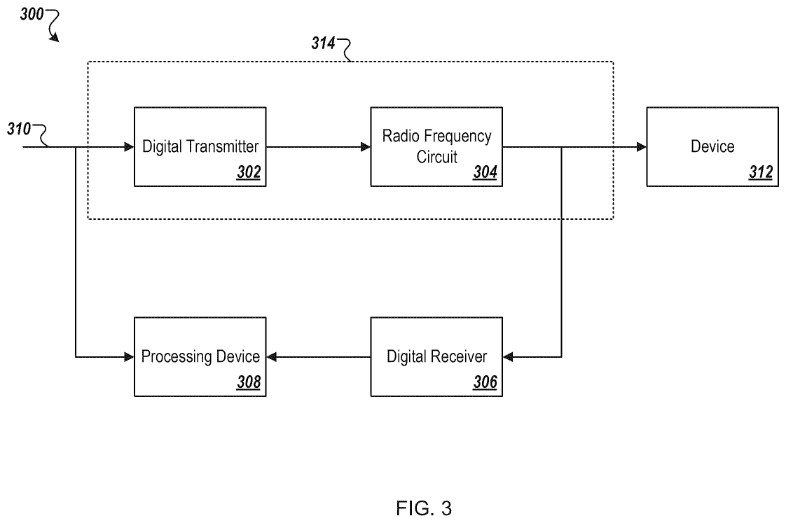

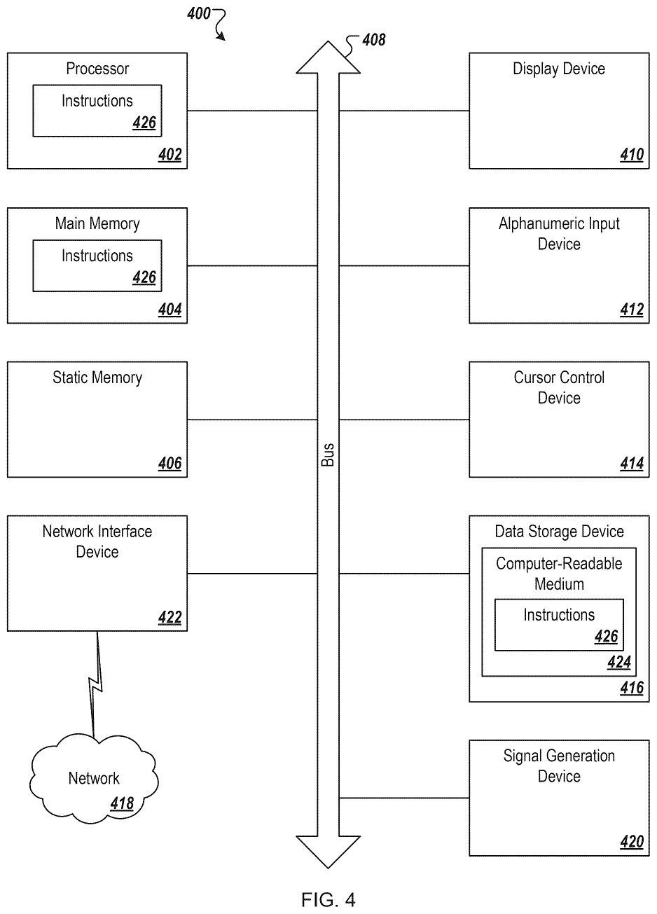

The method 200 may be performed by processing logic that may include hardware (circuitry, dedicated logic, etc.), software (such as is run on a computer system or a dedicated machine), or a combination of both, which processing logic may be included in the processing device 402 of FIG. 4, the communication system 300 of FIG. 3, or another device, combination of devices, or systems. The method 200 may begin at block 205 where the processing logic may connect digital signal processors (DSPs) to analog crossbars. At block 210, the processing logic may facilitate network isolation at the plurality of DSPs.

The processing logic may establish multiple security zones by configuring the DSPs to implement logical and physical boundaries within the AECS 100. This process may involve associating specific DSPs 110a, 110b, 110c, 110d with particular crossbars 120a, 120b, and assigning these associations to individual zones based on policy definitions. Security zones may be dynamically created, modified, or dissolved in response to network conditions, ensuring that resources are allocated efficiently while maintaining robust isolation.

The processing logic may apply hierarchical policies governing the operation of crossbar connections within and between security zones. Global policies set by the switch controller 130 may establish default permissions, while zone-specific policies may override or refine these rules based on zone. For example, a high-security zone may enforce additional restrictions on crossbar connections, such as prohibiting external traffic or limiting bandwidth to critical data streams. The hierarchical structure may ensure consistency across the network while allowing for tailored configurations at the zone level.

The processing logic may validate policies in real-time prior to enforcement. The switch controller 130 may simulate proposed policy changes to evaluate their impact on crossbar configurations, resource allocation, and traffic flows. If potential conflicts or performance issues are detected, the processing logic may generate alerts or recommendations for alternative configurations. Real-time validation ensures that policy updates are seamlessly integrated without introducing disruptions or compromising system stability.

The processing logic may monitor traffic flows across crossbar connections for compliance with established policies. This monitoring may include analyzing packet headers, traffic patterns, and zone-specific behaviors to detect unauthorized access, policy violations, or anomalies. When violations are identified, the processing logic may log the event, flag the affected crossbar connections, and initiate corrective actions, such as rerouting traffic or temporarily isolating the compromised zone.

The processing logic may leverage asynchronous operation to independently reconfigure DSPs and crossbars in response to policy updates or network demands. Each DSP may adjust its state based on localized conditions without waiting for global synchronization, enabling rapid adaptations to traffic patterns or emerging threats. Localized synchronization between subsets of DSPs and crossbars may ensure operation within individual zones while preserving the flexibility of asynchronous configurations.

The processing logic may implement time-division multiplexing (TDM) to allocate crossbar resources among overlapping security zones. Using predefined scheduling algorithms, the processing logic may dynamically share crossbar bandwidth across zones based on traffic priorities, latency, and administrative directives. TDM ensures efficient utilization of shared resources while maintaining strict boundaries between traffic flows from different zones.

The processing logic may provide redundancy for traffic isolation and failover. This may include activating redundant crossbars or alternate paths to maintain connectivity during hardware failures or policy reconfigurations. Redundant input and output lanes may be dynamically assigned to affected zones, ensuring uninterrupted traffic flow and enhanced system resilience.

The processing logic may enforce access controls for authorized traffic and control signals. DSPs 110a, 110b, 110c, 110d may verify the credentials of incoming traffic and reject unauthorized access attempts. Similarly, control commands issued to configure crossbars or manage resources may be authenticated by the switch controller 130 to ensure they originate from trusted sources. Access control policies may be updated dynamically to respond to detected security threats or changes in administrative priorities.

The processing logic may log all crossbar configurations, policy enforcement actions, and traffic management decisions for auditing and compliance purposes. Logs may be stored in tamper-evident formats, such as cryptographically hashed records, providing a verifiable history of the AECS 100's operations. These logs may be used to generate compliance reports, support forensic investigations, or validate adherence to regulations.

The processing logic may generate reports summarizing the current state of traffic isolation, security zones, and resource utilization within the AECS 100. These reports may be accessible to administrators through a management interface, offering real-time insights into network performance and security. Detailed visualizations of traffic flows, zone configurations, and policy impacts may aid in decision-making and system optimization.

The processing logic may integrate machine learning algorithms to enhance traffic isolation and policy enforcement. These algorithms may analyze historical and real-time traffic data to identify patterns, predict potential bottlenecks, and recommend policy updates. For example, if a zone experiences sustained high traffic volumes, the processing logic may suggest creating additional zones or reallocating crossbar resources to alleviate congestion.

The processing logic may facilitate interoperability between the AECS 100 and legacy systems or third-party devices. Protocol translation layers within DSPs 110a, 110b, 110c, 110d may enable seamless communication across diverse infrastructures while maintaining strict isolation policies. This interoperability ensures that the AECS 100 can be deployed in complex, heterogeneous networking environments without compromising its traffic isolation capabilities.

The processing logic may support automated testing and certification of traffic isolation policies. By simulating various traffic scenarios, the AECS 100 may verify the robustness of its isolation mechanisms and generate certification documents for compliance with industry standards. Automated testing ensures that the system remains reliable and secure under a wide range of operating conditions.

Accordingly, such features described above enhance the versatility and robustness of AECS 100, ensuring its ability to dynamically adapt to complex networking environments, enforce rigorous traffic isolation policies, and maintain high levels of security and performance. The integration of asynchronous operation, hierarchical policy management, and real-time monitoring establishes the AECS 100 as a state-of-the-art solution for modern traffic isolation challenges.

The processing logic may apply a policy for permitting a crossbar connection between the plurality of DSPs and the plurality of analog crossbars. The processing logic may apply a policy for banning a crossbar connection between the plurality of DSPs and the plurality of analog crossbars. The processing logic may monitor a crossbar connection between the plurality of DSPs and the plurality of analog crossbars for a policy violation. The processing logic may form a plurality of security zones. The processing logic may use one or more of a redundant crossbar or a failover path to facilitate operation during failover. The processing logic may control access for one or more of authorized traffic or control signals. The processing logic may apply a policy to physically isolate one or more nodes. The processing logic may designate one or more DSPs of the plurality of DSPs as controllers for other security zones.

Modifications, additions, or omissions may be made to the method 200 without departing from the scope of the present disclosure. For example, in some examples, the method 200 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 3 illustrates a block diagram of an example communication system 300, in accordance with at least one example described in the present disclosure. The communication system 300 may include a digital transmitter 302, a radio frequency circuit 304, a device 312, a digital receiver 306, and a processing device 308. The digital transmitter 302 and the processing device may be configured to receive a baseband signal via connection 310. A transceiver 314 may comprise the digital transmitter 302 and the radio frequency circuit 304.

In some examples, the communication system 300 may include a system of devices that may be configured to communicate with one another via a wired or wireline connection. For example, a wired connection in the communication system 300 may include one or more Ethernet cables, one or more fiber-optic cables, and/or other similar wired communication mediums. Alternatively, or additionally, the communication system 300 may include a system of devices that may be configured to communicate via one or more wireless connections. For example, the communication system 300 may include one or more devices configured to transmit and/or receive radio waves, microwaves, ultrasonic waves, optical waves, electromagnetic induction, and/or similar wireless communications. Alternatively, or additionally, the communication system 300 may include combinations of wireless and/or wired connections. In these and other examples, the communication system 300 may include one or more devices that may be configured to obtain a baseband signal, perform one or more operations to the baseband signal to generate a modified baseband signal, and transmit the modified baseband signal, such as to one or more loads.

In some examples, the communication system 300 may include one or more communication channels that may communicatively couple systems and/or devices included in the communication system 300. For example, the transceiver 314 may be communicatively coupled to the device 312.

In some examples, the transceiver 314 may be configured to obtain a baseband signal. For example, as described herein, the transceiver 314 may be configured to generate a baseband signal and/or receive a baseband signal from another device. In some examples, the transceiver 314 may be configured to transmit the baseband signal. For example, upon obtaining the baseband signal, the transceiver 314 may be configured to transmit the baseband signal to a separate device, such as the device 312. Alternatively, or additionally, the transceiver 314 may be configured to modify, condition, and/or transform the baseband signal in advance of transmitting the baseband signal. For example, the transceiver 314 may include a quadrature up-converter and/or a digital to analog converter (DAC) that may be configured to modify the baseband signal. Alternatively, or additionally, the transceiver 314 may include a direct radio frequency (RF) sampling converter that may be configured to modify the baseband signal.

In some examples, the digital transmitter 302 may be configured to obtain a baseband signal via connection 310. In some examples, the digital transmitter 302 may be configured to up-convert the baseband signal. For example, the digital transmitter 302 may include a quadrature up-converter to apply to the baseband signal. In some examples, the digital transmitter 302 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 302.

In some examples, the transceiver 314 may include one or more subcomponents that may be used in preparing the baseband signal and/or transmitting the baseband signal. For example, the transceiver 314 may include an RF front end (e.g., in a wireless environment) which may include a power amplifier (PA), a digital transmitter (e.g., 302), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 304) of the transceiver 314 may be synchronized with the resource controller via the S-plane device, which may contribute to high-accuracy timing with respect to a reference clock.

In some examples, the transceiver 314 may be configured to obtain the baseband signal for transmission. For example, the transceiver 314 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 314 may be configured to generate a baseband signal for transmission. In these and other examples, the transceiver 314 may be configured to transmit the baseband signal to another device, such as the device 312.

In some examples, the device 312 may be configured to receive a transmission from the transceiver 314. For example, the transceiver 314 may be configured to transmit a baseband signal to the device 312.

In some examples, the radio frequency circuit 304 may be configured to transmit the digital signal received from the digital transmitter 302. In some examples, the radio frequency circuit 304 may be configured to transmit the digital signal to the device 312 and/or the digital receiver 306. In some examples, the digital receiver 306 may be configured to receive a digital signal from the RF circuit and/or send a digital signal to the processing device 308.

In some examples, the processing device 308 may be a standalone device or system, as illustrated. Alternatively, or additionally, the processing device 308 may be a component of another device and/or system. For example, in some examples, the processing device 308 may be included in the transceiver 314. In instances in which the processing device 308 is a standalone device or system, the processing device 308 may be configured to communicate with additional devices and/or systems remote from the processing device 308, such as the transceiver 314 and/or the device 312. For example, the processing device 308 may be configured to send and/or receive transmissions from the transceiver 314 and/or the device 312. In some examples, the processing device 308 may be combined with other elements of the communication system 300.

FIG. 4 illustrates a diagrammatic representation of a machine in the example form of a computing device 400 within which a set of instructions, for causing the machine to perform any one or more of the methods discussed herein, may be executed. The computing device 400 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a DSP, network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one example, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 424 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

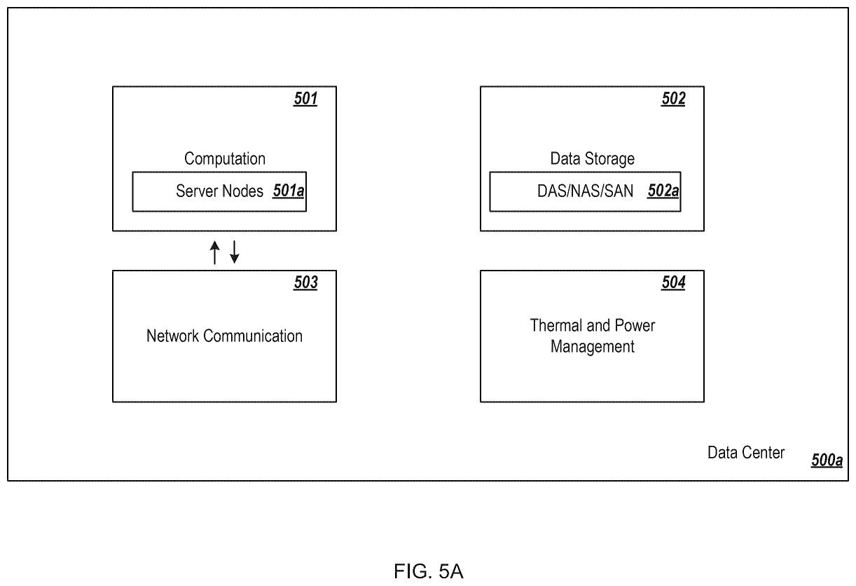

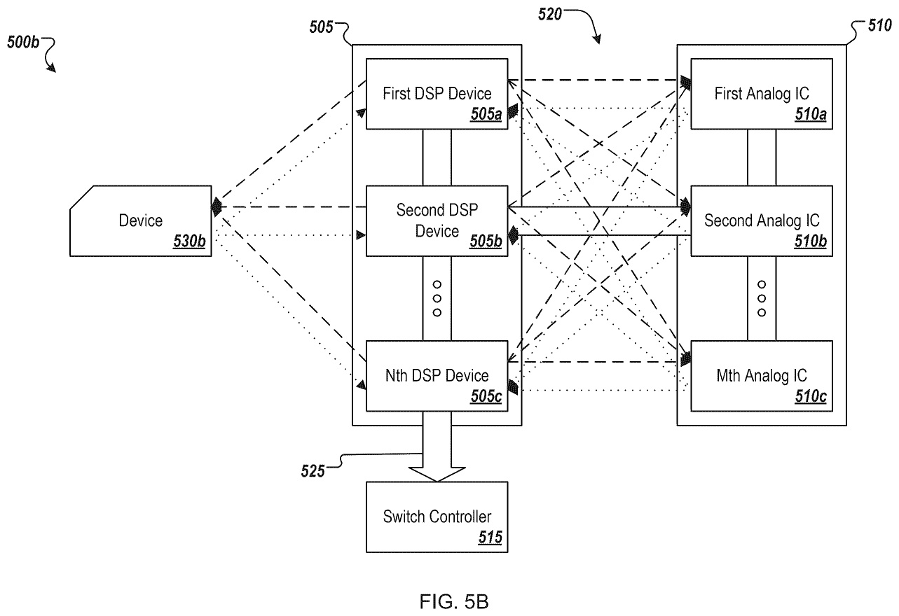

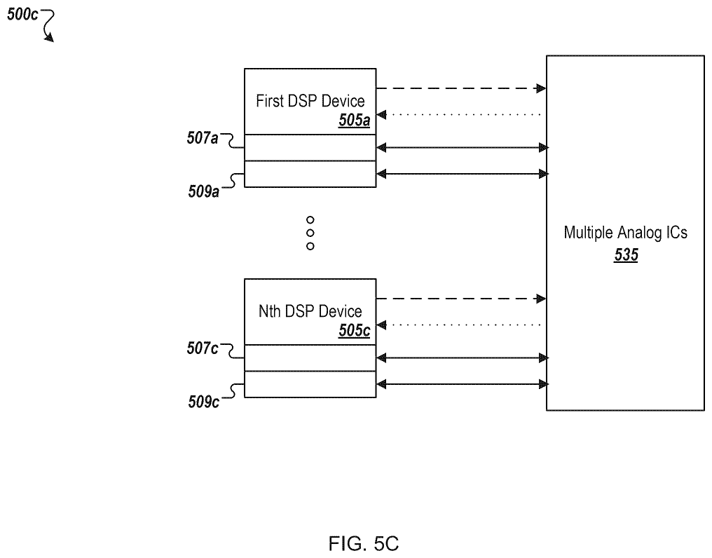

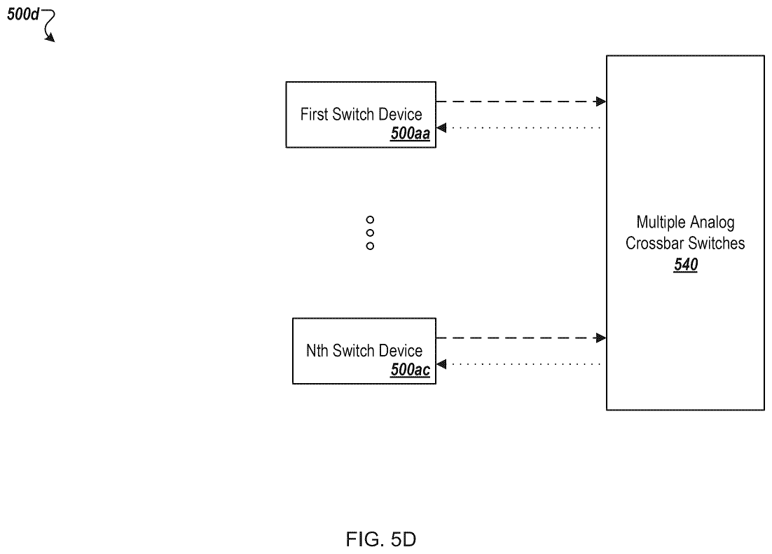

As illustrated in FIG. 5A, a block diagram of a data center 500a may include multiple subsystems configured to perform various operational functions, including computation 501, data storage 502, network communication 503, and thermal and power management 504. The computation 501 subsystem may include one or more server nodes 501a that may execute software applications and process data workloads. The data storage 502 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 502a. The networking communication 503 subsystem may facilitate bidirectional data transfer between servers and external networks through high-speed switching and routing components. The thermal and power management 504 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 500a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch systems on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, 1/5 of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 5B illustrates an example switch device 500b. The switch device 500b may include a first digital signal processor (DSP) device 505a, a second DSP device 505b, an nth DSP device 505c, referred to collectively as multiple first electronic devices 505, a first analog integrated circuit (IC) 510a, a second analog IC 510b, an mth analog IC 510c, referred to collectively as multiple second electronic devices 510, a switch controller 515, in-band traffic 520, and out-of-band traffic 525. First DSP 505a, second DSP 505b, and nth DSP 505c may have input and output.

The switch device 500b may be reconfigurable (e.g., in terms of the connections between the components therein, such as the multiple first electronic devices 505 and the multiple second electronic devices 510, the switch controller 515, and/or a device 530), where the switching of the connections/lanes between the components may be low latency (e.g., less than 5 ns, 10 ns, or the like switching). Alternatively, or additionally, the switch device 500b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 505 may individually include one or more ports that may be used to facilitate communications within the switch device 500b, such as between the multiple first electronic devices 505 and the multiple second electronic devices 510, the switch controller 515, and/or a device 530. The communications in the switch device 500b may be transmitted via multiple lanes in the switch device 500b. The multiple lanes may facilitate the in-band traffic 520 and/or the out-of-band traffic 525.

The multiple lanes between the multiple first electronic devices 505 and the multiple second electronic devices 510 may be in an any-to-any configuration. For example, the first DSP device 505a may include a lane to the first analog IC 510a, to the second analog IC 510b, and/or the mth analog IC 510c. A similar arrangement may occur for each of the multiple first electronic devices 505, such that each DSP device of the multiple first electronic devices 505 may include a lane to any number of the multiple second electronic devices 510, including none of the multiple second electronic devices 510. Each lane for facilitating the in-band traffic 520 may be in both directions (e.g., transmit and receive) between the multiple first electronic devices 505, the multiple second electronic devices 510, and/or a device 530. Alternatively, or additionally, the lanes are dashed/dotted to illustrate that for any transmit/receive path between the multiple first electronic devices 505, the multiple second electronic devices 510, and/or a device 530, a lane may or may not be present.

The multiple first electronic devices 505, the multiple second electronic devices 510, and/or the switch controller 515 may be disposed on a printed circuit board (PCB) where traces on the PCB may be used to connect at least the multiple first electronic devices 505, the multiple second electronic devices 510, and/or the switch controller 515 (e.g., the traces on the PCB may facilitate the in-band traffic 520 and/or the out-of-band traffic 525 in the switch device 500b). Alternatively, or additionally, the multiple first electronic devices 505, the multiple second electronic devices 510, and/or the switch controller 515 may be connected to one another using connectors, such as high-speed cables, where the multiple first electronic devices 505, the multiple second electronic devices 510, and/or the switch controller 515 may individually include ports/headers to support the use of the connectors. In instances in which the connectors are used, crosstalk between the multiple lanes in the switch device 500b may be reduced relative to the crosstalk that may occur when the switch device 500b uses traces on a PCB.

The switch device 500b, including the multiple first electronic devices 505, the multiple second electronic devices 510, and/or the switch controller 515, may be utilized with one or more additional switches and/or crossbar devices to form a new crossbar switch device, which may be larger than any one of the switch devices 500b. For example, as illustrated and discussed relative to FIG. 5C, the switch device 500b may be utilized with any other number of switch devices 500b (e.g., the nth switch device 500ac in FIG. 5C) and multiple analog crossbar switches 540 to form a new crossbar switch device.

The multiple first electronic devices 505 may be digital signal processors (DSPs) and/or the multiple second electronic devices 510 may be analog circuit switch integrated circuits (ICs) for use with electrical signals. Alternatively, or additionally the multiple second electronic devices 510 may be analog optical circuit switch ICs for use with optical signals. The multiple first electronic devices 505 may be individually configured to support one or more layer of the open systems interconnection (OSI) model. For example, each of the multiple first electronic devices 505 may be configured to support layer 1 protocols, layer 2 protocols, and/or layer 3 protocols with respect to the in-band traffic 520 and/or the out-of-band traffic 525.

Each, or at least one, of the multiple first electronic devices 505 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 505 may be able to adjust the way in which traffic is directed through it, such as in response to a command from the switch controller 515. For example, each of the multiple first electronic devices 505 may be operable to configure an internal switch, an external switch, or a crossbar based on the various layer protocol processing to be performed.

The first DSP device 505a may receive a communication that includes a frame header (or a packet header) and the first DSP device 505a may be configured to detect the frame header and decode the frame header along with any associated contents of the communication, all within the first DSP device 505a. In a second example, the first DSP device 505a may integrate a media access control (MAC) address lookup table which may allow the first DSP device 505a to configure one or more crossbars such that the first DSP device 505a may facilitate connectivity between any two MAC addresses that are included in the lookup table. Alternatively, or additionally, each of the first electronic devices 505 may include a lookup table that may store equalization settings that may be used for various connections between the first electronic devices 505 and other components within the switch device 500b. The equalization settings in the lookup table may be used to accelerate acquisition and/or tracking for a particular DSP device of the multiple first electronic devices 505 when the particular DSP device switches connections within the switch device 500b.

The multiple first electronic devices 505 may be configured to respond to layer 2 protocol requests and/or layer 3 protocol requests for connectivity and/or resource grant requests. For example, the multiple first electronic devices 505 may compare a request to a lookup table that includes priority levels and the multiple first electronic devices 505 may be operable to configure themselves and/or associated crossbars and/or switches based on the determined priority level. Alternatively, or additionally, each of the multiple first electronic devices 505 may be configured to respond to in-band requests (e.g., granting a connection request, signaling backpressure to the device 530, etc.), collect statistics on traffic handled by the multiple first electronic devices 505 (e.g., link utilization and/or traffic type), and/or perform data filtering (e.g., detecting a particular header, performing routing, generating flags and/or interrupts, and/or logging any of the filtering events).

The multiple first electronic devices 505 may be configured to communicate with (e.g., transmit data to and/or receive data from) the device 530. The communication with the device 530 may include in-band traffic 520. In such instances, the communications between the multiple first electronic devices 505 and the device 530 may be line-side communications, where the lines may facilitate communications using various communication channels. For example, the line-side communications between the multiple first electronic devices 505 and the device 530 may be an electrical-to-electrical connection, an optical-to-optical connection, an electrical-to-optical connection, or an optical-to-electrical connection, and so forth.

The device 530 may address communications directly to one of the multiple first electronic devices 505. For example, the device 530 may address communications to the second DSP device 505b. Alternatively, or additionally, the device 530 may address communications to the switch controller 515, which may then direct communications to the appropriate DSP device. For example, the device 530 may address communications intended for the second DSP device 505b to the switch controller 515 and the switch controller 515 may direct the communications to the second DSP device 505b.

The multiple first electronic devices 505 may individually include memory that may be used as a buffer for communications through the multiple first electronic devices 505. The memory in the multiple first electronic devices 505 may be utilized to buffer incoming and/or outgoing traffic, which may include in-band traffic 520 and/or out-of-band traffic 525. Due to the memory in the multiple first electronic devices 505 being distributed (e.g., by the distributed nature of the multiple first electronic devices 505), the switch device 500b may not include any memory for buffering in addition to the memory included in the multiple first electronic devices 505.

The multiple first electronic devices 505 may individually include one or more additional lanes that may be used for communications in the switch device 500b. Further details associated with the additional lanes are included in the description associated with FIG. 5C.

The multiple second electronic devices 510 may individually include one or more ports that may be used to facilitate communications within the switch device 500b, similar to the ports described relative to the multiple first electronic devices 505. Alternatively, or additionally, the lanes for communications between the multiple first electronic devices 505 and the multiple second electronic devices 510 may be coupled with the ports included in the multiple second electronic devices 510.

The switch controller 515 may be a microcontroller unit (MCU). Alternatively, or additionally, the switch controller 515 may be a DSP, or other processing device. The switch controller 515 may be communicatively coupled with at least the multiple first electronic devices 505 and/or the multiple second electronic devices 510. The switch controller 515 may resolve resource grant requests, distribute the network state to the multiple first electronic devices 505 and/or to the multiple second electronic device 510, and/or may establish and/or maintain timing among the components included in the switch device 500b.

The switch controller 515 may communicate with the multiple first electronic devices 505 and/or the multiple second electronic devices 510 using a separate connection/lane than the connections between the multiple first electronic devices 505 and the multiple second electronic devices 510. For example, the first connection between the multiple first electronic devices 505 and the multiple second electronic devices 510 may facilitate the in-band traffic 520 and the second connection between the switch controller 515 and the multiple first electronic devices 505 and/or the multiple second electronic devices 510 may facilitate the out-of-band traffic 525.

The out-of-band traffic 525 may use a different network than the in-band traffic 520. Alternatively, or additionally, the out-of-band traffic 525 may use a different physical layer protocol than the in-band traffic 520. The out-of-band traffic 525 may be used to manage and/or configure one or more components included in the switch device 500b. For example, the switch controller 515 may communicate with the multiple first electronic devices 505 using the out-of-band traffic 525 to reconfigure lanes and/or traffic routing based on the traffic through the switch device 500b.

The switch controller 515 may be programmable such that the switch controller 515 may be operable to dynamically map the lanes between the multiple first electronic devices 505 and the multiple second electronic devices 510. For example, in instances in which the first DSP device 505a includes a lane to the first analog IC 510a, the switch controller 515 may dynamically map the lane to be from the first DSP device 505a to the second analog IC 510b. The switch controller 515 may dynamically adapt the mapping of the lanes between the multiple first electronic devices 505 and the multiple second electronic devices 510 based on one or more conditions and/or a satisfaction of a threshold related to the conditions. For example, in instances in which the real-time data traffic in the switch device 500b (or an amount of real-time data traffic handled by one of the multiple first electronic devices 505 and/or one of the multiple second electronic devices 510) satisfies a threshold, the switch controller 515 may dynamically adapt the mapping of the lanes as described.

The switch device 500b may include one or more redundant lanes that may be used in various situations during operation of the switch device 500b. For example, one or more redundant lanes may be used for the out-of-band traffic 525, such as signaling using the out-of-band traffic 525. In such instances, the out-of-band signaling may be transmitted and/or received by a particular DSP device and/or by the switch controller 515, and the out-of-band signaling may be a lower transmission rate than the in-band traffic 520. In another example, one or more redundant lanes may be used for out-of-bandwidth broadcasts from the switch controller 515 and/or from one or more of the multiple first electronic devices 505 to other devices in the switch device 500b (e.g., such as other DSP devices).

The switch controller 515 may reserve a portion of bandwidth associated with the in-band traffic 520 in the switch device 500b. The bandwidth reserved by the switch controller 515 may be reserved on a per lane basis of the multiple lanes included in the switch device 500b. For example, a first lane between the first DSP device 505a and the first analog IC 510a may have a first reserved bandwidth and a second lane between the second DSP device 505b and the second analog IC 510b may have a second reserved bandwidth, where the amount of bandwidth reserved may be the same or may differ between the first reserved bandwidth and the second reserved bandwidth. The switch controller 515 may allocate resources within the switch device 500b based on predicted or anticipated traffic (e.g., based on a probabilistic model).

Alternatively, or additionally, the switch controller 515 may monitor the lanes of the multiple lanes in the switch device 500b. The switch controller 515 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 515 may dynamically remap a new lane in the switch device 500b to replace the degraded lane.

The switch controller 515 may perform adaptive signal equalization to the in-band traffic 520 in the switch device 500b. For example, the multiple first electronic devices 505 may provide feedback to the switch controller 515 relative to the workload handled by the multiple first electronic devices 505, and the switch controller 515 may adaptively manage workloads of the multiple first electronic devices 505 to optimize performance of the switch device 500b.

A backup switch controller (not illustrated) may be included in the switch device 500b. The backup switch controller may be a redundant controller relative to the switch controller 515. The backup switch controller may include the same or similar connections as the switch controller 515 relative to the multiple first electronic devices 505 and/or the multiple second electronic devices 510. The backup switch controller may perform the same or similar operations as the switch controller 515.

FIG. 5C illustrates an example switch device 500c. The switch device 500c may include a first DSP device 505a, an nth DSP device 505c, and multiple analog ICs 535. The first DSP device 505a may include a first auxiliary channel 507a, and a first out-of-band channel 509a. The nth DSP device 505c may include an nth auxiliary channel 507c, and an nth out-of-band channel 509c.

The first DSP device 505a, the nth DSP device 505c, and the multiple analog ICs 535 may be the same or similar as the first DSP device 505a, the nth DSP device 505c, and the multiple second electronic devices 510, respectively, of FIG. 5A and may be operable to perform the same or similar functions as described.

The auxiliary channels 507 (e.g., the first auxiliary channel 507a and the second auxiliary channel 507c) may be individually utilized by each of the DSP devices 505a, 505c as an additional lane for in-band traffic between at least the DSP devices 505a, 505c and the multiple analog ICs 535. The auxiliary channels 507 may be used to redundantly transmit in-band traffic relative to another lane included in the DSP devices 505a, 505c prior to a change in configuration to the corresponding DSP devices 505a, 505c. For example, in instances in which the first DSP device 505a includes a lane to a particular analog IC of the multiple analog ICs 535 and the first DSP device 505a is to be reconfigured (e.g., by a switch controller as described herein), the first auxiliary channel 507a may have a lane mapped to the particular analog IC such that the in-band traffic is redundant between the first DSP device 505a and the particular analog IC prior to reconfiguring the lanes associated with the first DSP device 505a (which reconfiguration may otherwise break the connection between the first DSP device 505a and the particular analog IC).

The auxiliary channels 507 may be used for communication between other near DSP devices. For example, in instances in which the first DSP device 505a is disposed spatially near to the nth DSP device 505c, the first DSP device 505a and the nth DSP device 505c may communicate with one another via the auxiliary channels 507. Such communications may be possible as the channels between near-neighbors may be relatively clean, such that physical layer processing may be simplified and may result in power reduction, latency reduction, a lesser amount of equalization, and/or other benefits to the switch device 500c.

The out-of-band channels 509 may be used to communicate the out-of-band traffic (e.g., the out-of-band traffic 525 of FIG. 5B) on a lane separate from the multiple lanes used to communicate in-band traffic. In such instances, the out-of-band channels 509 may not cause blocking or interference to the in-band traffic between at least the DSP devices 505a, 505c and the multiple analog ICs 535.

FIG. 5D illustrates an example aggregated switch device 500d. The aggregated switch device 500d may include a first switch device 500aa, an nth switch device 500ac, and multiple analog crossbar switches 540. The first switch device 500aa and the nth switch device 500ac may individually be the same or similar as the switch device 500b of FIG. 5B.

The aggregated switch device 500d illustrates that any number of the switch devices 500b (e.g., the first switch device 500aa and the nth switch device 500ac) may be aggregated into another switch device and/or connected to other analog crossbar switches. Each of the switch devices 500b may include multiple DSP devices and multiple analog IC and may be further aggregated into the aggregated switch device 500d using the multiple analog crossbar switches 540. As such, the aggregated switch device 500d may be scaled up or down for any size communication need, by adjusting the switch devices 500b and/or the multiple analog crossbar switches 540 to meet the communication demand.

### EXAMPLES

A device may include a plurality of DSPs; a plurality of analog crossbars operable to be connected to the plurality of DSPs; and a switch controller operable to manage traffic isolation policies and facilitate real-time reconfiguration of crossbar connections. The switch controller may apply policies to physically isolate one or more nodes and prevent unauthorized connections between security zones. The switch controller may determine one or more DSPs of the plurality of DSPs as controllers for specific security zones, and determine zone controllers corresponding to the one or more DSPs based on traffic demands or system priorities. The switch controller may simulate the impact of policy changes on existing crossbar configurations and flag potential conflicts prior to enforcement. The switch controller and DSPs may collectively facilitate localized synchronization between subsets of DSPs and crossbars to support asynchronous operation, enabling faster reconfiguration and reduced reliance on global timing mechanisms.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs); and
a plurality of analog crossbars operable to be connected to the plurality of DSPs, wherein a microcontroller unit is operable to facilitate network isolation.

2. The device of claim 1, wherein the microcontroller unit is operable to:
apply hierarchical policies for permitting a crossbar connection between the plurality of DSPs and the plurality of analog crossbars,
wherein zone-specific policies inherit and may override global policies set by the microcontroller unit.

3. The device of claim 1, wherein the microcontroller unit is operable to:
apply policies for banning crossbar connections between the plurality of DSPs and the plurality of analog crossbars in response to detected anomalies or security breaches.

4. The device of claim 1, wherein the microcontroller unit is operable to monitor crossbar connections in real-time to:
detect policy violations,
log unauthorized access attempts, and
initiate corrective actions including isolating affected crossbars.

5. The device of claim 1, wherein the microcontroller unit is operable to:
form and dynamically reconfigure multiple security zones to isolate traffic at varying levels of granularity, including logical and physical boundaries.

6. The device of claim 1, further comprising:
one or more redundant crossbars or failover paths operable to ensure uninterrupted operation during hardware failures or network reconfigurations.

7. The device of claim 1, wherein a security monitoring function is separate from a security controlling function.

8. A method, comprising:
connecting a plurality of digital signal processors (DSPs) to a plurality of analog crossbars; and
facilitating network isolation at the plurality of DSPs.

9. The method of claim 8, further comprising:
applying hierarchical policies to manage crossbar connections, including global rules set by a switch controller and zone-specific rules tailored to individual security zones.

10. The method of claim 8, further comprising:
dynamically updating policies based on real-time network conditions, including traffic patterns, security events, and administrative directives.

11. The method of claim 8, further comprising:
monitoring crossbar connections to detect policy violations, log unauthorized access attempts, and enforce corrective actions, including rerouting or isolating traffic.

12. The method of claim 8, further comprising:
forming multiple security zones by associating DSPs and crossbars with logical and physical boundaries, and
dynamically reconfiguring zones based on traffic demands or detected threats.

13. The method of claim 8, further comprising:
using one or more redundant crossbars or failover paths to ensure uninterrupted operation during hardware failures or policy updates.

14. The method of claim 8, further comprising:
implementing localized synchronization between subsets of DSPs and crossbars to support asynchronous operation, enabling faster reconfiguration and efficient resource allocation.

15. The method of claim 8, further comprising:
using time-division multiplexing (TDM) to allocate crossbar bandwidth across overlapping security zones, ensuring efficient resource utilization while maintaining strict traffic isolation.

16. The method of claim 8, further comprising:
simulating an impact of policy changes on crossbar configurations and traffic flows to validate updates and prevent system instability.

17. The method of claim 8, further comprising:
generating and storing tamper-evident logs of crossbar configurations, policy enforcement actions, and traffic management decisions for auditing and compliance purposes.

18. The method of claim 8, further comprising:
integrating machine learning algorithms to analyze traffic patterns, predict congestion or security threats, and recommend policy updates or zone reconfigurations.

19. The method of claim 8, further comprising:
supporting interoperability with legacy systems or third-party devices through protocol translation layers within the DSPs, ensuring compatibility while maintaining traffic isolation.

20. A device, comprising:
a plurality of DSPs;
a plurality of analog crossbars operable to be connected to the plurality of DSPs; and
a switch controller operable to manage traffic isolation policies.
